(19) United States
(12) Patent Application Publication
(10) Pub. No.: US 2026/0166541 A1
(43) Pub. Date: Jun. 18, 2026

(54) PIPETTE TIP AND METHOD FOR PRODUCING THE PIPETTE TIP

(71) Applicant: Ritter GmbH, Schwabmünchen (DE)

(72) Inventors: Annika RAFFLER, Untermeitingen (DE); Dominik GEIGER, Hurlach (DE); Johannes WOLFERT, Bonstetten (DE); Frank FINIS, Augsburg (DE); Sebastian KERTZSCHER, Lagerlechfeld (DE)

(21) Appl. No.: 18/709,779

(22) PCT Filed: Nov. 14, 2022
(86) PCT No.: PCT/EP2022/081851

§ 371 Date: May 13, 2024

(30) Foreign Application Priority Data
Nov. 16, 2021 (DE) 10 2021 129 888.1

(51) Int. Cl. B01L 3/02; B29C 45/00

(52) U.S. Cl. CPC B01L 3/0275; B29C 45/00; B01L 2200/0689

(57) ABSTRACT

A pipette tip has a wall defining an interior space; an upper opening and a lower opening are disposed at the upper end and the lower end of the interior space. A fifth of five adjoining sections opens into the lower opening, with transition areas between each of the neighboring sections. The upper opening has a larger diameter than the diameter of the lower opening. The interior space has at least in sections cylindrical and/or tapering from top to bottom sections and/or transition areas. The interior space has at least one section and/or a transition area which widens from top to bottom so that an undercut is formed.

### TECHNICAL AREA

This application relates to disposable pipette tips, in particular pipette tips made of plastic, and to a method for manufacturing pipette tips.

### BACKGROUND

Automatic pipetting machines are used in a variety of analytical applications for the transfer of liquids. Disposable pipette tips are used in these machines. Disposable pipette tips are usually conical in shape from top to bottom and may have particularly shaped sections for gripping and sealing.

Reliable gripping may take place on the outside or inside of the wall of the pipette tip. For this purpose lockable or expandable gripping devices may be used. The pipette tip may have corresponding gripping profiles on the outside or inside, which are designed to complement the contact profile of the gripping device and prevent the pipette tip from slipping off or being pulled away from the closed gripping device. For example, grooves or ridges may be provided in an upper area of the wall of the pipette tip on the inside or outside.

Sealing between a mandrel of the automatic pipetting machine, which penetrates into the interior space of the pipette tip, and the pipette tip may be provided, for example, by an O-ring, which may rest on a step formed in the interior of the pipette tip, the interior space being tapered by the step.

Generally, the inner contours of conventional pipette tips are cylindrical, conical or tapered in sections in order to enable simple production in an injection molding process with simple removal of the pipette tip from the inner core of an injection mold.

### SUMMARY

Based on this, it is an object of the present disclosure to provide a pipette tip and a method for manufacturing the pipette tip, which ensure secure gripping of an automatic pipetting machine and at the same time provide reliable sealing of the pipette tip and a mandrel of an automatic pipetting machine.

This problem is solved by a pipette tip and a method disclosed herein. the present disclosure The present disclosure has as its object (disposable) pipette tips comprising: a wall defining an interior space; a first upper opening and a second lower opening disposed at the upper end and the lower end of the interior space, respectively; a first section adjoining the upper opening; a second section adjoining the first section; a third section adjoining the second section; and a fourth section adjoining the third section; and a fifth section adjoining the fourth section and ending at the lower opening; a first transition area between the first section and the second section; a second transition area between the second section and the third section; a third transition area between the third section and the fourth section; wherein the sections and the transition areas have an internal contour or internal geometry or a form according to the following description of the present disclosure.

The term “top” (“above”) refers to an area of the wall or interior space of the pipette tip closer to the first, upper opening, into which a holding/sealing mandrel of the automatic pipetting machine may penetrate as intended in order to hold and seal the pipette tip. The term “bottom” (“below”) refers to an area of the wall or the interior space of the pipette tip closer to the second, lower opening, through which the pipetted fluid is intended to be aspirated or dispensed during operation. The upper opening is usually larger than the lower opening.

The direction “from top to bottom” means the axial direction from the upper opening to the lower opening. “Axial” is a direction perpendicular to a plane defined by the upper and/or lower edge of the pipette tip. “Radial” means a direction parallel to the plane defined by the upper and/or lower edge of the pipette tip, i.e. perpendicular to “axial”. A tapering or reduction in cross-section from top to bottom means that the cross-section in a position closer to the first opening is larger than the cross-section in a position closer to the second opening. A widening or increase in cross-section occurs when the cross-section in a position closer to the first opening is smaller than the cross-section in a position closer to the second opening. This applies both to the sections of the pipette tip and to the transition areas.

Sections of the wall or the interior space of the pipette tip have an axial and optionally also a radial extension. In some embodiments transition areas of the wall or the interior space of the pipette tip may have an axial extension and/or a radial extension. However, in other embodiments they may be formed as a continuous transition without axial/radial extension, e.g. as an edge.

An undercut or back taper is present when there is a widening or increase in cross-section (when viewing the interior space through the upper opening in the direction of the lower opening), as described above. An undercut may be a continuous transition with axial or without axial extension. A pipette tip according to the present disclosure comprises: a wall defining an interior space; a first upper opening and a second lower opening located at the upper end and the lower end of the interior space, respectively; a first section adjoining the upper opening; a second section adjoining the first section; a third section adjoining the second section; a fourth section adjoining the third section; and a fifth section adjoining the fourth section and ending in the lower opening; a first transition area between the first section and the second section; a second transition area between the second section and the third section; and a third transition area between the third section and the fourth section; wherein the diameter of the upper opening is greater than the diameter of the lower opening; wherein the interior space has, at least in sections, cylindrical sections and/or sections tapering from top to bottom and/or transition areas; and wherein the interior space has at least one section and/or one transition area which widens from top to bottom so that an undercut is formed.

In a preferred embodiment the first section has an upper diameter D1 corresponding to the diameter of the upper opening, a bulgy inwardly extending lower region with a diameter smaller than D1, wherein the lower region of the first section merges into the first transition area, which has a diameter D2 that is larger than the diameter of the lower region of the first section, so that the first transition area forms a first undercut. In particular, the second section adjoining the first transition area has a cylindrical and/or conical inner contour that tapers from top to bottom. The interior space of the second section is thus cylindrical or funnel-shaped.

The second transition area adjoining the second section may have a conically tapering and/or radially inwardly extending step (with a radial surface), with the third section adjoining below the second transition area.

The diameter D3 of the second section directly above the second transition area is in particular larger than the diameter D4 of the third section directly below the second transition area.

The second transition area may have a radial surface or a surface with a radial extension component with one or more axially or obliquely (with axial component) upwardly extending protrusions or teeth, which extend in a circumferential direction or which are arranged at a distance from one another in the circumferential direction.

The shape of the protrusions is arbitrary. They may be manufactured as edged fillets, rounded hemispheres, pyramids, etc. The protrusions may, for example, be provided as damping elements of the second transition area if the second transition area is provided as a stop or seal. Together with the wall of the pipette tip, they may define an annular groove into which a sealing or damping element, e.g. an O-ring, may be inserted.

In a preferred embodiment the third section has a cylindrical and/or conical inner contour that widens from top to bottom.

The fourth section may have a cylindrical and/or conical inner contour that widens from top to bottom. In the case of a widening contour, a second undercut is formed in the third transition area.

The third transition area between the third section and the fourth section may have at least one inwardly extending protrusion, whereby the smallest diameter of the third transition area is smaller than the diameter D5 of the third section directly above the third transition area and smaller than the diameter D6 of the fourth section directly below the third transition area. The third transition area (possibly together with the fourth section) thus forms a second undercut.

Particularly, the diameter D5 of the third section directly above the third transition area is smaller than the diameter D6 of the fourth section directly below the third transition area.

Alternatively, the diameter D5 of the third section directly above the third transition area may be larger than the diameter D6 of the fourth section directly below the third transition area. However, the smallest diameter of the third transition area may be smaller than the diameter D6 of the fourth section directly below the third transition area and/or smaller than the diameter D5 of the third section directly above the third transition area.

Particularly, in a preferred embodiment of the present disclosure, the third section has an inner contour which has at least one region which widens from top to bottom in order to form a third undercut.

The second section may have an inner contour that has at least one area that widens from top to bottom.

The third transition area may have one or more protrusions, the protrusion having a first flank with a first radius (R1), a tip projecting radially towards the central axis of the interior space(S) with a second radius (R2), and a second flank with a third radius (R3), wherein the radii R1, R2, R3 fulfill the following conditions: R1=R2=R3, or R1=R2<R3, or R1=R3>R2, or R2=R3>R1, or R1<R2<R3, or R1>R2<R3. If there are several protrusions, the radii may be different and fulfil different ones of the above conditions. The radii determine the steepness of the flank rise of a protrusion, the shape of the inwardly projecting peak and the steepness of the flank fall. Overall, the number and shape of the protrusion(s) determine(s) how many and what geometry the undercuts have, and thus the force with which the pipette tip adheres to the molding core when the outer mold is removed, or the force required to pull the pipette tip off the inner core. Since in the context of the present disclosure it is preferred that several undercuts are provided in the inner region of the pipette tip, a secure adhesion of the pipette tip to the core may be achieved without the inner contour being impaired by forced demolding when the pipette tip is removed from the inner core.

In particular, the pipette tip is manufactured as a disposable product and preferably as a single piece or in one piece made of plastic.

The interior space may be cylindrical and/or conically tapering in the third section and conically tapering in the fourth section, whereby the cross-sectional reduction of the fourth section is greater than that of the third section, and whereby the third transition area is designed as an angle.

In particular, the third transition area may be continuous in the form of an edge or a curvature. The fourth section may serve as a contact surface for a sealing element of the automatic pipetting machine.

An injection molding process according to the present disclosure for producing a pipette tip as described above comprises the following steps: providing an injection molding cavity formed by an inner core and an outer sleeve and corresponding to the wall contour of the pipette tip; introducing liquid plastic into the cavity; solidifying the plastic; removing the outer sleeve from the outer contour of the pipette tip while the pipette tip remains on the core; withdrawing the pipette tip from the core in the axial direction.

In particular, the removal of the outer sleeve may comprise a movement of the sleeve or parts of the sleeve in a radial direction or in a direction with a radial directional component. During this process, the solidified pipette tip according to the present disclosure adheres securely to the inner core of the injection molding tool due to the special inner contour of the wall and, in particular, due to the formation of one or more undercuts.

### BRIEF DESCRIPTION OF THE DRAWINGS

Further features and advantages of the present disclosure will become clear from the following description with reference to the figures. The figures show:

FIG. 1 a sectional view of a basic structure of a pipette tip according to the present disclosure;

FIG. 2 a first particular embodiment of the present disclosure;

FIG. 3 a second particular embodiment of the present disclosure;

FIG. 4 a third particular embodiment of the present disclosure;

FIG. 5 a fourth particular embodiment of the present disclosure;

FIG. 6 a fifth particular embodiment of the present disclosure;

FIG. 7 a sixth particular embodiment of the present disclosure;

FIG. 8 a seventh particular embodiment of the present disclosure;

FIGS. 9-11 an eighth particular embodiment of the present disclosure;

FIG. 12 a ninth particular embodiment of the present disclosure;

FIG. 13 a tenth particular embodiment of the present disclosure;

FIG. 14 an eleventh particular embodiment of the present disclosure;

FIG. 15 a twelfth particular embodiment of the present disclosure;

FIG. 16 a thirteenth particular embodiment of the present disclosure;

FIG. 17 a fourteenth particular embodiment of the present disclosure;

FIG. 18 a fifteenth particular embodiment of the present disclosure;

FIG. 19 a sixteenth particular embodiment of the present disclosure;

FIG. 20 a seventeenth specific embodiment of the present disclosure;

FIG. 21 an eighteenth particular embodiment of the present disclosure;

FIG. 22 a nineteenth particular embodiment of the present disclosure;

FIG. 23 a twentieth particular embodiment of the present disclosure;

FIG. 24 a twenty-first specific embodiment of the present disclosure;

FIG. 25 a twenty-second specific embodiment of the present disclosure;

FIG. 26 variants of a detail of the twentieth and twenty-first embodiments of the present disclosure;

FIG. 27 further variants of a detail of the twentieth and twenty-first embodiment of the present disclosure;

FIG. 28 further variants of a detail of the twentieth and twenty-first embodiment of the present disclosure;

FIG. 29 a twenty-third embodiment of the present disclosure.

### DETAILED DESCRIPTION

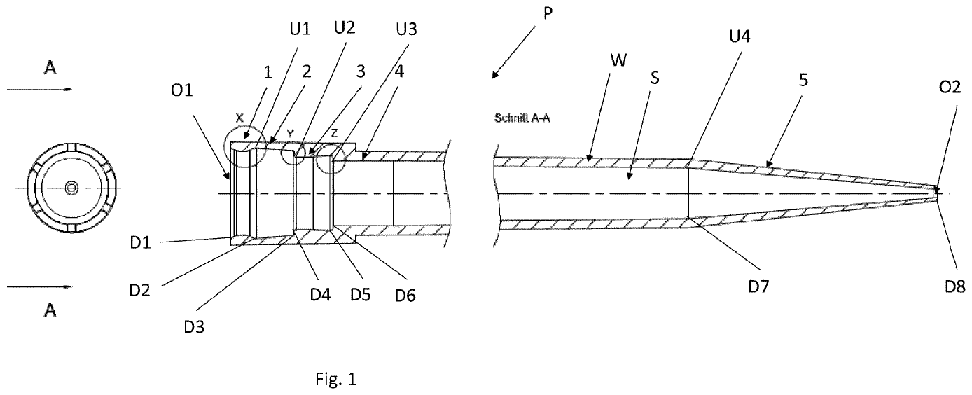

FIG. 1 shows a sectional view of the basic structure of a pipette tip P according to the present disclosure.

The pipette tip P has a first, upper (or proximal) opening O1 and a second, lower (or distal) opening O2. A wall W delimits the interior space S between the openings O1 and O2.

The upper opening O1 has a first diameter D1. The upper opening O1 is adjoined by a first section 1 with a first inner contour. The upper end of the first section 1 corresponds to the diameter of the upper opening O1. The lower end of the first section 1 has a diameter D2.

The first section 1 passes into a second section 2 having a second inner contour. The upper end of the second section 2 has a diameter D2. The lower end of the second section 2 has a diameter D3.

The second section 2 passes into a third section 3 having a third inner contour. The upper end of the third section 3 has a diameter D4. The lower end of the third section 3 has a diameter D5.

The third section 3 passes into a fourth section 4 with a fourth inner contour. The upper end of the fourth section 4 has a diameter D6. The lower end of the fourth section 4 has a diameter D7.

The fourth section 4 passes into a fifth section 5 with a fifth inner contour. The upper end of the fifth section 5 has the diameter D7. The lower end of the fifth section 5 ends at the second, lower (distal) opening O2 and the diameter of the lower end of the fifth section 5 corresponds to the diameter D8 of the lower opening O2.

The different sections may be directly adjacent to each other. This is particularly the case if the diameter of the lower end of a section corresponds to the diameter of the upper end of a subsequent or adjoining section. A transition area U1, U2, U3 or U4 is formed between each of the adjoining sections. The transition area may have no extension, i.e. it may be formed as a continuous transition between the respective sections 1 to 5. It may have a steep gradient or be formed as an edge. However, the transition area, i.e. its inner contour, may also have an extension in the axial and/or radial direction. This means that the inner contour of the transition may be designed as a cylinder, an incline, a step, a taper (cross-section reduction of the inner contour) and/or a widening of the inner contour. However, the inner contour of the transition area may also have several steps or combinations of the described inner contours.

Within the scope of the disclosure, it should be possible to combine all features of the embodiments described below. In particular, this means that the described transitions or stops between the sections of the pipette tip should be within the scope of the disclosure of the present disclosure in any combination.

Particular examples of inner contours and transitions are described with respect to the following particular embodiments. In each case, only the upper sections of the pipette tip are shown. The fourth section 4 may have a substantially cylindrical or frustoconical (i.e. tapered) shape, or a combination thereof. The fifth section 5 is frustoconical (i.e. tapering) and opens into the second opening O2.

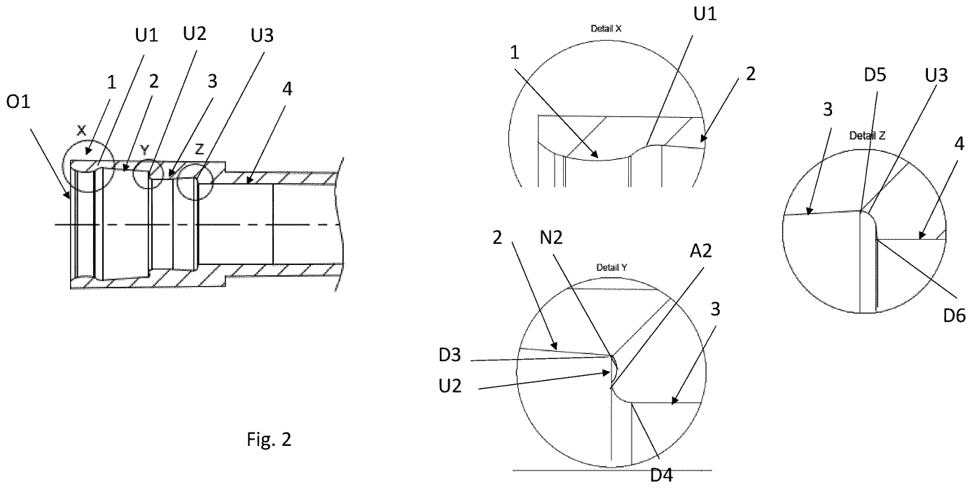

FIG. 2 shows a first particular embodiment of the present disclosure.

The first section 1 is designed as a bead that extends convexly radially inwards. The second section 2 is (essentially) designed as a truncated cone section tapering downwards. The transition area U1 (detail x) is a continuous transition. The diameter D1 is larger than the diameter D2 at the transition area U1. The diameter D3 is smaller than the diameter D2.

The transition area U2 (detail y) is a continuous transition with an essentially radial extension. Essentially, the transition area U2 is designed as a step extending radially inwards, which forms a stop. Since the step U2 has a continuous or interrupted protrusion A2 extending along the circumference on the inside of the step, a groove N2 is formed between the lower end of the second section 2 and the protrusion A2. However, the transition area U2 could also be formed as a practically flat step without the protrusion(s) A2.

The third section 3 has an inner contour in the form of a downwardly widening truncated cone section. The diameter D2 is larger than the diameter D3. The diameter D3 is greater than the diameter D4. The diameter D4 is smaller than the diameter D5. The transition area U3 (detail z) is a continuous transition with an essentially radial extension. Essentially, the transition area U3 is formed as a step extending radially inwards, whereby the transition to the lower end of the third section 3 is rounded and the transition to the upper end of the fourth section 4 forms an edge.

The fourth section 4 has an inner contour in the form of a cylindrical or slightly downwardly tapering truncated cone section. The diameter D5 is greater than the diameter D6. The diameter D6 is greater than or equal to the diameter D7. The diameter D7 is greater than the diameter D8 of the lower (second) opening O2.

In the description of the following variants, only the differences of each variant with respect to the first particular embodiment or the previously described particular embodiments will be discussed.

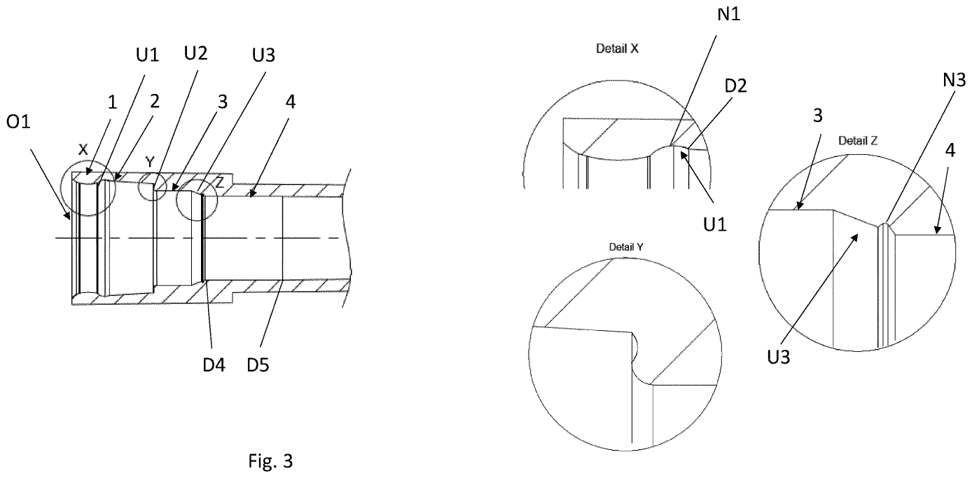

FIG. 3 shows a second particular embodiment of the present disclosure. In contrast to the first particular embodiment, the transition area U1 (detail x) has an axial extension. The transition area U1 is designed as a radial groove N1 extending in the circumferential direction.

In addition, the transition area U3 (detail z) is designed differently. Following the third section 3, it has a tapering inner contour in the form of a downwardly tapering truncated cone section. In the transition to the fourth section 4, the transition area U3 has a radial groove N3 extending in the circumferential direction.

In this embodiment, the third section 3 is essentially cylindrical. The diameter D4 corresponds to the diameter D5.

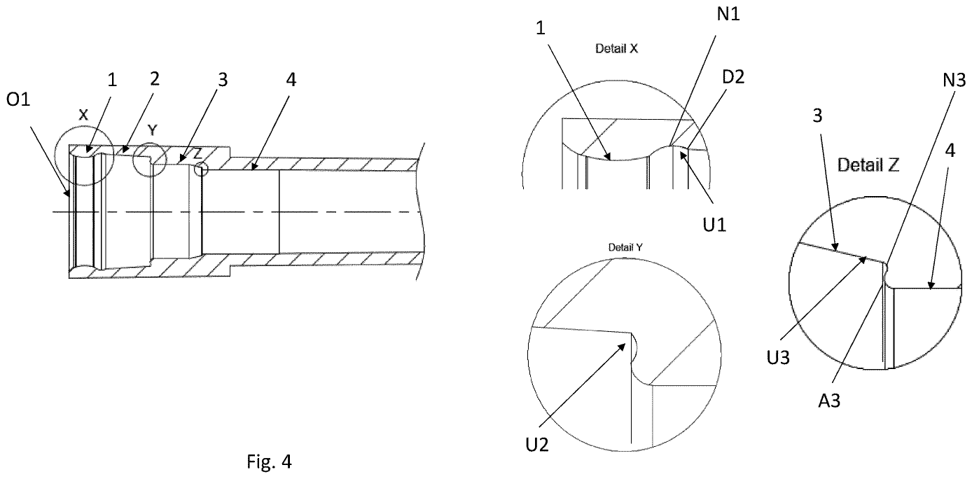

FIG. 4 shows a third particular embodiment of the present disclosure. In contrast to the second particular embodiment, the transition area U3 (detail z) is formed in a stepped manner as a step extending radially inwards. Since the step U3 has a continuous or interrupted elevation A3 extending along the circumference on the inside of the step, a groove N3 extending along the circumference is formed between the lower end of the third section 3 and the elevation A3.

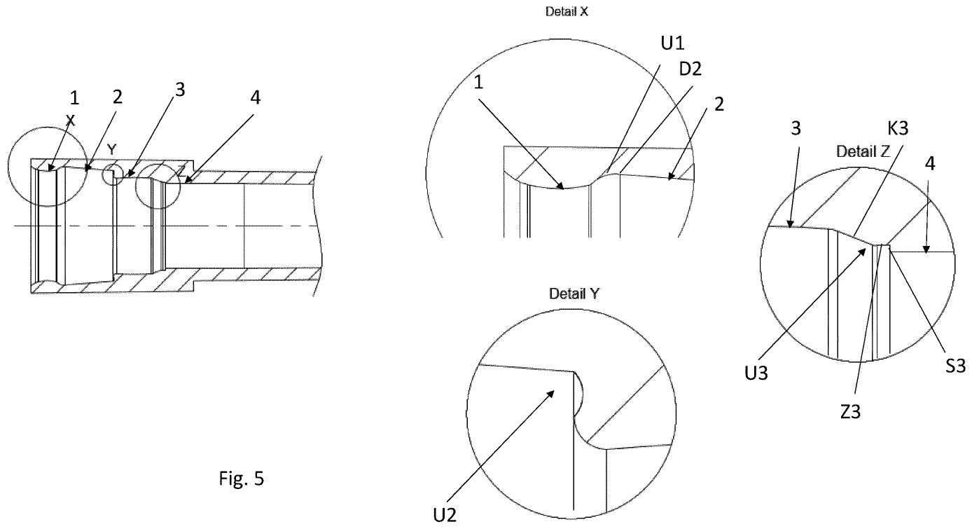

FIG. 5 shows a fourth particular embodiment of the present disclosure. The transition area U1 between the first section 1 and the second section 2 forms an undercut behind the bead (bulbous elevation) of the first section 1, which merges continuously and with the same diameter D2 into the second section 2. There is no groove provided.

In contrast to the first particular embodiment, the third section 3 passes into transition area U3 (detail z) which has a tapering inner contour in the form of a downwardly tapering truncated cone section K3. In the transition to the fourth section 4, the transition area U3 has a cylindrical section Z3 and a step S3 extending inwards towards the fourth section 4.

Section 3 is essentially cylindrical.

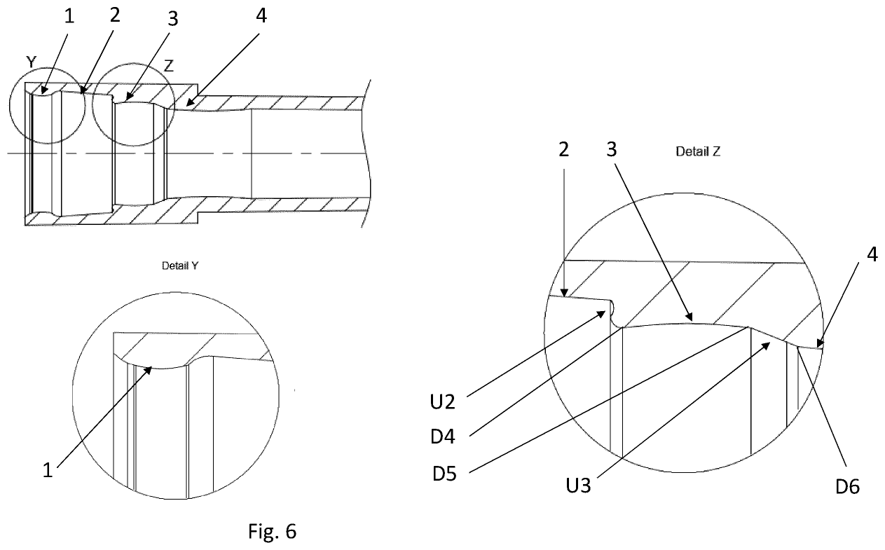

FIG. 6 shows a fifth particular embodiment of the present disclosure. Sections 1 and 2 and the transition areas U1 and U2 correspond to the first and fourth embodiments, respectively. Section 3 is essentially cylindrical, but with a slight concave curvature towards the outside. D4 is approximately the same size as D5 (detail z).

The transition area U3 (detail z) is designed as an inclined, inwardly tapering surface in the form of a truncated cone section. Section 4 is tapered and conical.

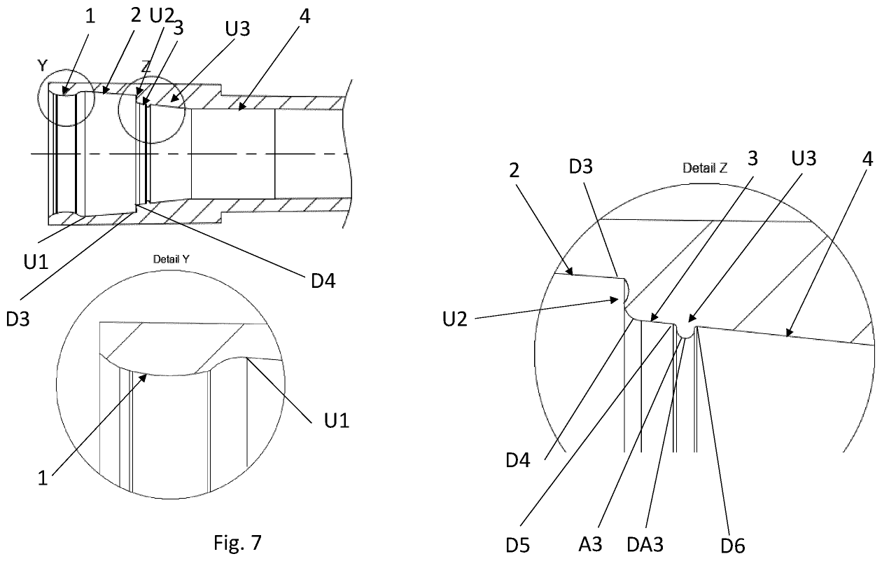

FIG. 7 shows a sixth particular embodiment of the present disclosure. Sections 1 and 2 as well as the transition areas U1 and U2 correspond to the first embodiment. Section 3 is shorter than in the previously described embodiments. It has the shape of a downwardly tapering truncated cone section. The transition area U3 has a protrusion A3 extending along the circumference with an inner diameter DA3 that is smaller than the diameters D5 and D6. The fourth section 4 has, at least in an upper area, the shape of a tapering truncated cone section, the pitch of which corresponds to that of section 3. The diameters D3 to D8 are in the following relationship: D3>D4>D5>D6>D7>D8.

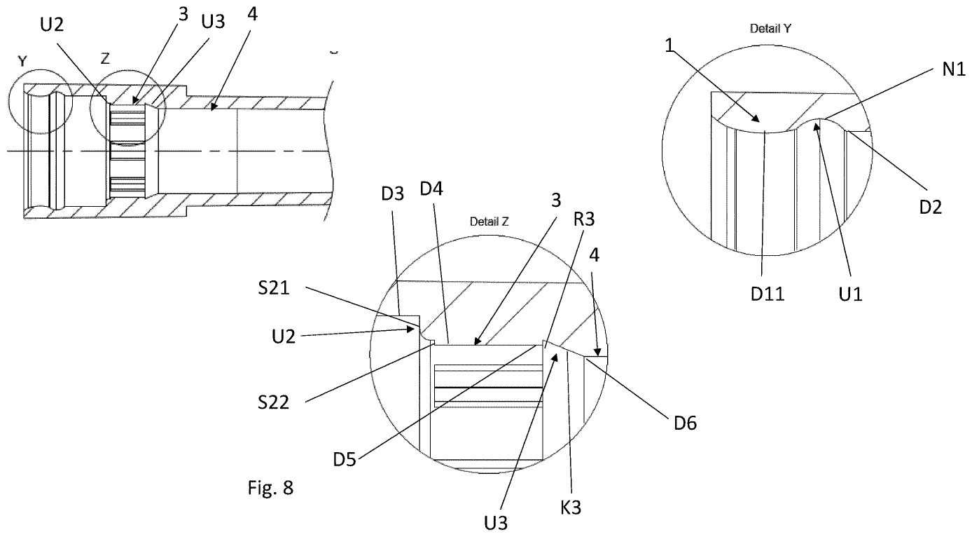

FIG. 8 shows a seventh particular embodiment of the present disclosure. The transition area U1 is designed like the transition area U1 of the second embodiment, with the difference that the radius D2 of the adjoining second section 2 corresponds approximately to the radius D11 of the innermost point of the bead 1 and the second section 2 is essentially cylindrical (D2=D3).

The transition area U2 is in the form of two successive radial steps S21 and S22. The transition between steps 21 and 22 is an arc that extends over approximately 90°. Section 3 is cylindrical (D3>D4=D5>D6).

The transition area U3 has a recess (viewed from top to bottom) R3 and a conical annular surface K3 directly adjacent to it, which (viewed from top) extends obliquely inwards to section 4. The diameter D6 is smaller than the diameter D5.

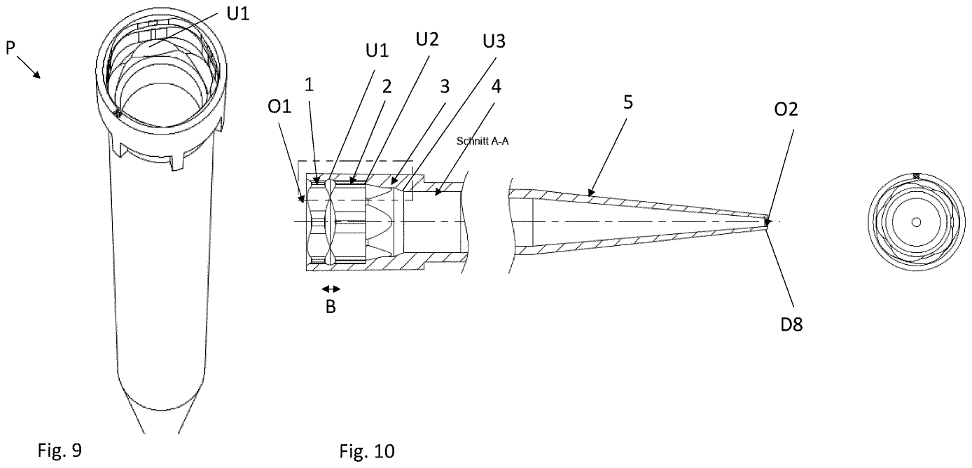

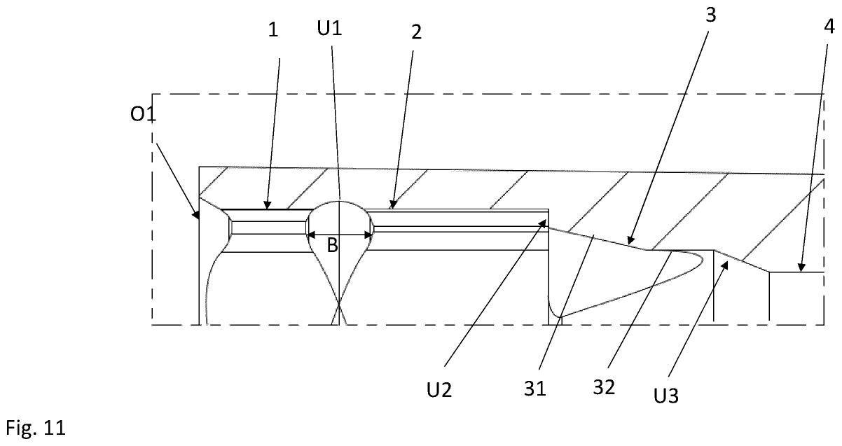

FIGS. 9 to 11 show an eighth particular embodiment of the present disclosure.

FIG. 11 shows the upper section of the pipette tip. Section 1 and section 2 are cylindrical with the same diameter D2. The first transition area U1 is formed as an outwardly extending concave groove. Unlike in the previous embodiments, however, the groove U1 is not formed continuously along the circumference with the same (axial) width B, as may be seen from FIGS. 8 and 9, but the width varies periodically along the circumference between a minimum width (up to zero) and a maximum width B. The pipette tip has a similar structure with a non-continuous diameter along the circumference in the upper opening area O1 and in section 3.

The transition area U2 is designed as a radial step.

Section 3 has a conically inwardly extending area 31 (viewed from top to bottom) and a cylindrical (or conically outwardly extending) area 32. The diameter of these areas, in particular of area 31, may vary along the circumference by providing periodically arranged, inwardly extending bulges or protrusions.

The transition area U3 has a conical inner contour inwardly tapered (seen from top to bottom).

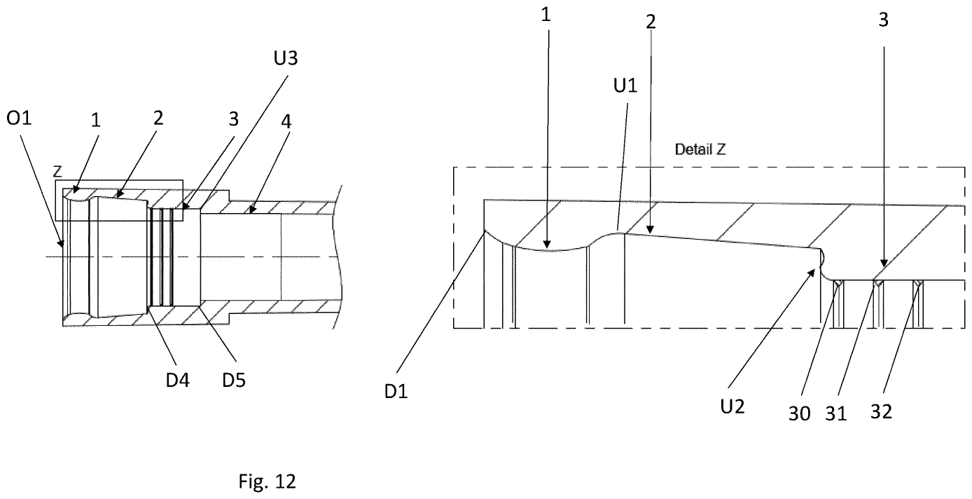

FIG. 12 shows a ninth particular embodiment of the present disclosure. Sections/transition areas 1, U1, 2, U2 correspond to the first embodiment. In the ninth embodiment, however, the third section 3 is cylindrical (D4=D5). It has radially inwardly projecting and axially spaced lips or protrusions 30, 31, 32 extending along the circumference.

The transition area U3 is designed as a step projecting radially inwards.

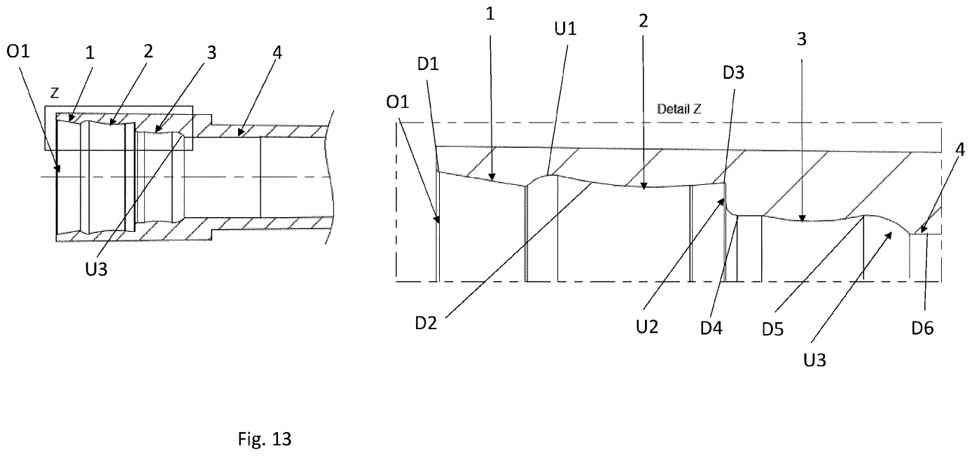

FIG. 13 shows a tenth particular embodiment of the present disclosure. Areas 1 and U1 correspond approximately to the first embodiment. Section 2 is cylindrical with a bulbous curvature towards the inside approximately in the center. Transition area U2 is an inwardly projecting step with a rounded transition to section 3. Section 3 is also cylindrical with a bulbous curvature approximately in the center towards the inside. Section 3 merges rounded into the transition area U3, which extends inwards and merges into the cylindrical section 4 via an edge. The following relation applies: D4=D5>D6.

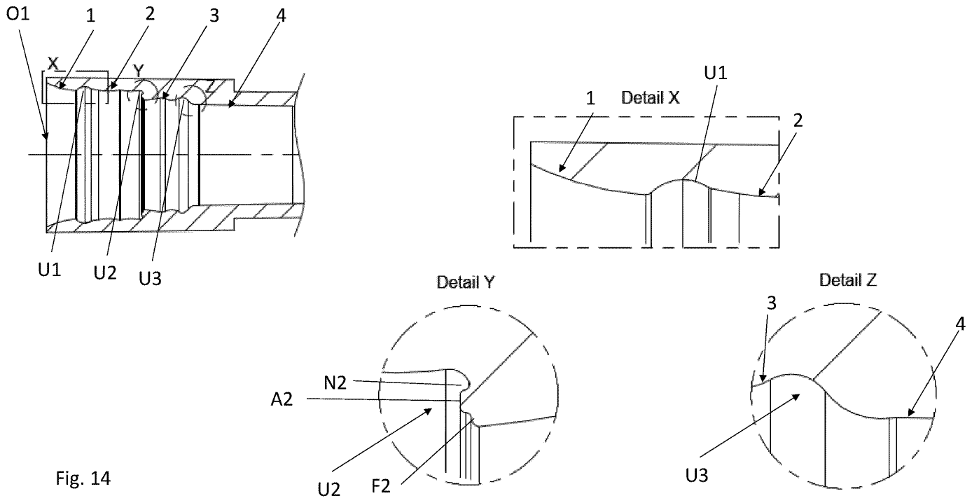

FIG. 14 shows an eleventh particular embodiment of the present disclosure. Areas 1, U1, and 2 (detail x) correspond to the tenth embodiment.

The transition area U2 (detail y) is essentially designed as a step with rounded transitions to sections 2 and 3. A protrusion A2 is formed in the center of the radially inwardly projecting step surface, which projects axially upwards and has a plateau-like surface between its two flanks. A groove N2 is formed between the outer flank and section 2. A ring-like step surface F2 is formed between the inner flank of the protrusion A2 and section 3.

Section 3 and the transition area U3 are curved. The inner contour of section 3 (viewed from top to bottom) has a first outwardly running curve and a second inwardly running curve merging into section 4.

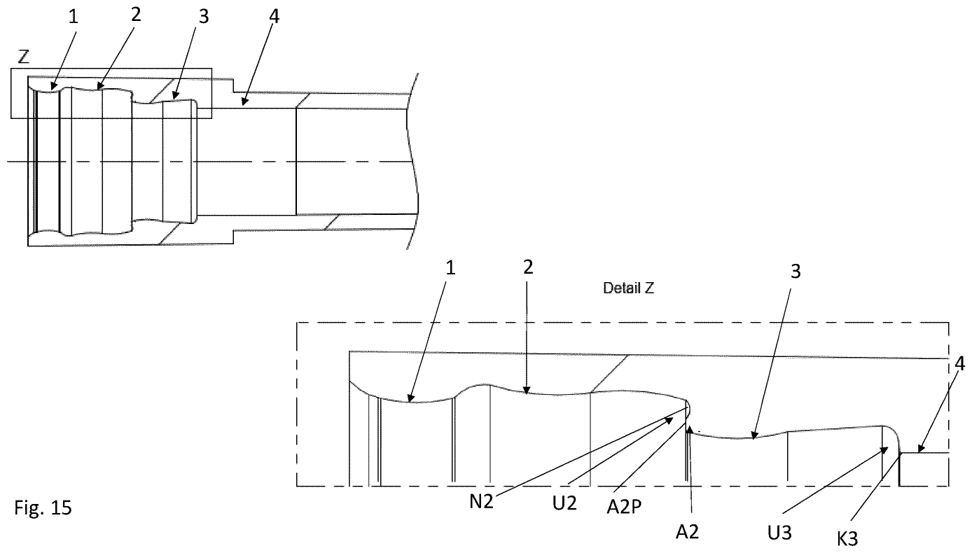

FIG. 15 shows a twelfth particular embodiment of the present disclosure. This embodiment differs from the tenth embodiment in that a groove N2 is formed in the transition area U2, which extends in the circumferential direction and is delimited inwards by an annular axial protrusion A2, which has a radially extending annular plateau A2P.

The transition area U3 is designed as a step with a rounded transition between section 3 and U3 and an edge at the transition between U3 and section 4.

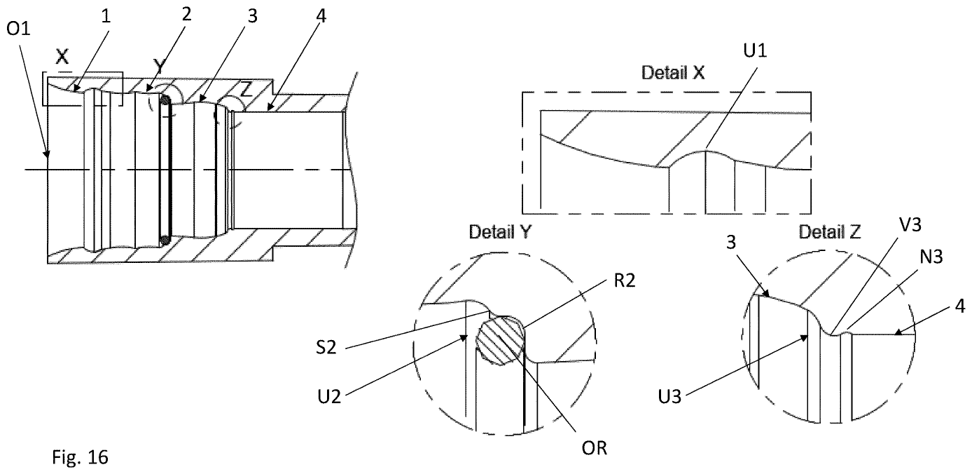

FIG. 16 shows a thirteenth particular embodiment of the present disclosure. This embodiment corresponds approximately to the eleventh embodiment (FIG. 14) in regions 1, U1 and 2 (detail x).

The transition area U2 (detail y) has a step S2 extending radially inwards from section 2. In the (radially) inner area of the step S2, a quarter-circular recess R2 is formed in the profile, in which a sealing ring (O-ring OR) is arranged.

Section 3 has an inwardly running bulge merging into transition area U3. The curvature of the bulge increases towards the transition area U3. The transition area U3 (detail z) has a (possibly radial) inwardly projecting protrusion V3 and an adjacent annular groove N3. The transition area U3 merges into section 4.

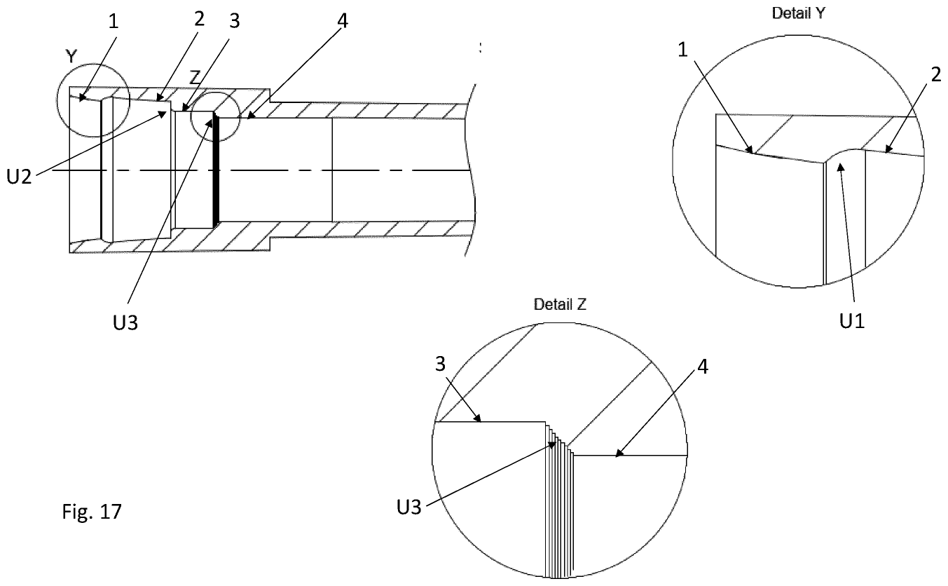

FIG. 17 shows a fourteenth particular embodiment of the present disclosure. This embodiment differs from the preceding embodiments primarily in that the transition area U2 is formed as a step, and the transition area U3 (detail z) is formed as a series of a plurality of small steps.

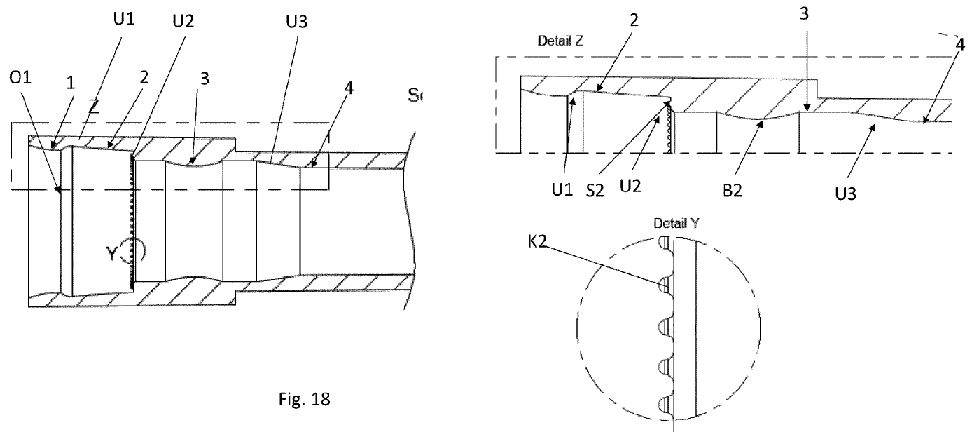

FIG. 18 shows a fifteenth particular embodiment of the present disclosure.

Sections 1 and 2 and the transition area U1 may be designed as described with reference to the previous embodiment. For example, section 1 may be designed as a bead and section 2 as a section that tapers slightly downwards.

The transition area U2 between section 2 and section 3 is a particular feature of this embodiment. In principle, the transition area is designed as a step S2. However, on the inner edge of the step, elevations K2 are arranged continuously or discontinuously distributed along the circumference, which extend axially upwards in the direction of the first opening O1. The protrusions K2 are spaced apart from one another. For example, they may be (semi-)spherical, such as a Gaussian curve, in the form of small pins or pyramids. The elevations K2 may, for example, exert a damping function when a plunger or mandrel (not shown) of an automatic pipetting machine contacts, or they may be elastic to a certain extent so that an elastic counterforce is exerted on a plunger pressing on them.

Section 3 has a bulbous center area B3 that extends inwards.

The transition area U3 has a slight taper (cross-section reduction). Alternatively, it may be formed without a cross-section reduction so that areas 3 and 4 are both cylindrical with the same diameter (D5=D6).

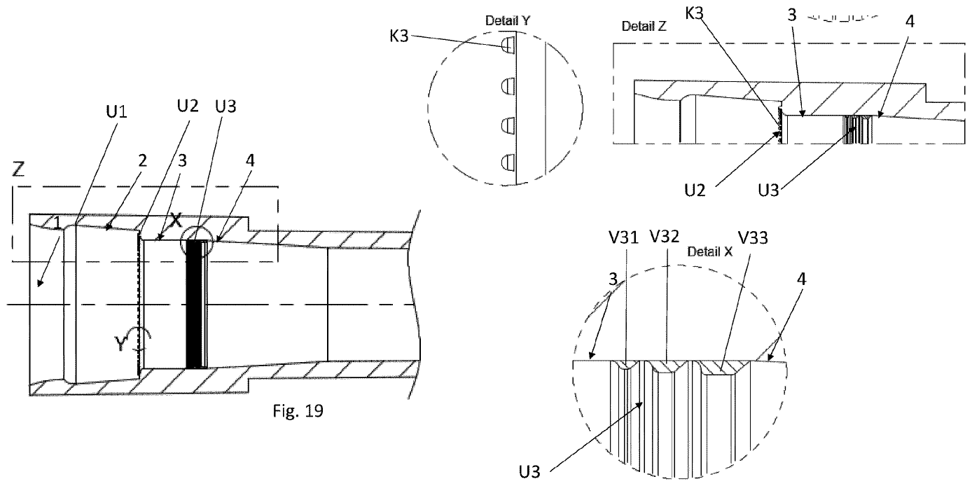

FIG. 19 shows a sixteenth particular embodiment of the present disclosure.

Sections 1 and 2 as well as the transition areas U1 and U2 may be formed as in any one of the previously described embodiments. However, the configuration of these sections and regions may be varied within the framework of the features described in connection with the present disclosure.

In this embodiment, the transition area U3 has annular protrusions or bulges V31, V32, V33 arranged between sections 3 and 4 (which have the same diameter (D5=D6)), and extend (radially or obliquely) inwards. The protrusions V31, V32, V33, in this embodiment three (3) protrusions, extend around the entire inner circumference, but have different cross-sections. The size of the bulges increases towards the bottom (in the direction to the opening O2). The upper bulge V31 has a lower height (and therefore a smaller inward extension) and a smaller axial extension than the center bulge V32 below it. The center bulge V32 has a lower height (and thus a smaller inward extension) and a smaller axial extension than the lower bulge V33 below it. The height and axial extension therefore increase downwards from bulge to bulge.

The shape of the (inwardly bulged) protrusions V31, V32, V33 is a (radial) elevation with a steeper front flank with respect to the axial extension, a plateau with a flat, i.e. axially aligned, upper side and a flatter rear flank with respect to the axial extension. Bulges (e.g. in the form of lips or ribs) that extend radially inwards and smoothly slope downwards axially towards the rear make it easier to pull out, for example, a seal of a mandrel of an automatic pipetting machine that is in contact with the bulges. In other words, ejection of a pipette tip is ensured by preventing the seal from getting caught. In this embodiment sections 3 and 4 are cylindrical. The transition area U3 is also essentially cylindrical with the three (3) ring-like bulges V31, V32, V33 extending inwards.

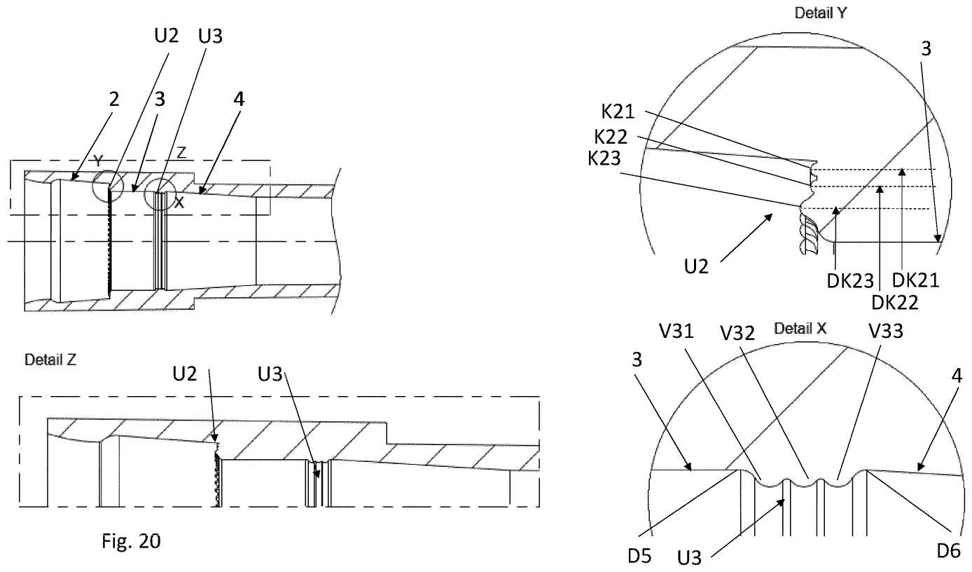

FIG. 20 shows a seventeenth particular embodiment of the present disclosure.

Sections 1 and 2 as well as the transition areas U1 are designed as in the previously described embodiments. However, the configuration of these sections and regions may be varied within the scope of the features described in connection with the present disclosure.

The transition area U2 between section 2 and section 3 is basically designed as a step S2 with a rounded transition between S2 and section 3. Groups of protrusions K21, K22, K23 are arranged on step S2, distributed continuously or discontinuously along the circumference and extending axially upwards/backwards. The protrusions K21, K22 and K23 are each arranged in a circle in the circumferential direction on step S2. The protrusions K21 are arranged on a circular line with a diameter DK21, the protrusions K22 on a circular line with a diameter DK22, and the protrusions K23 on a circular line with a diameter DK23, whereby D3>DK21>DK22>DK23<D4. The axial extent (height in relation to the step surface) of the innermost protrusion K23, on the other hand, is greater than the axial extent of the two outer protrusions K22 and K21, which are approximately the same height but could also differ in height. All protrusions K21, K22 and K23 could alternatively be of the same height. There may also be more or less than three (3) groups of protrusions K21, K22, K23.

The groups of protrusions K21, K22 and K23 are each arranged at a distance from each other in a circumferential direction. In profile they may be (semi-)spherical, such as a Gaussian curve, in the form of small pins or pyramids. The protrusions K21, K22 and K23 may, for example, provide a damping function or they may be elastic to a certain extent so that a punch pressing on them is exposed to an elastic counterforce. The transition area U3 is formed approximately as in the previous embodiment. It has annular protrusions or bulges V31, V32, V33 extending (radially or obliquely) inwards between sections 3 and 4, which have the same diameter (D5=D6). The protrusions V31, V32, V33, in this case three (3) protrusions, extend along the entire inner circumference. Their cross-section is essentially identical, i.e. they have approximately the same size and shape. However, variations in number, size and shape are conceivable.

The shape of the (inwardly bulged) protrusions V31, V32, V33 is a curved elevation with a front flank and a rear flank.

In this embodiment sections 3 and 4 are cylindrical. The transition area U3 carrying the three (3) inwardly extending ring-like bulges V31, V32, V33 is also essentially cylindrical. The diameter D5 of the top end of the transition area U3 may be smaller than or equal to the diameter D6 at the bottom end of the transition area U3.

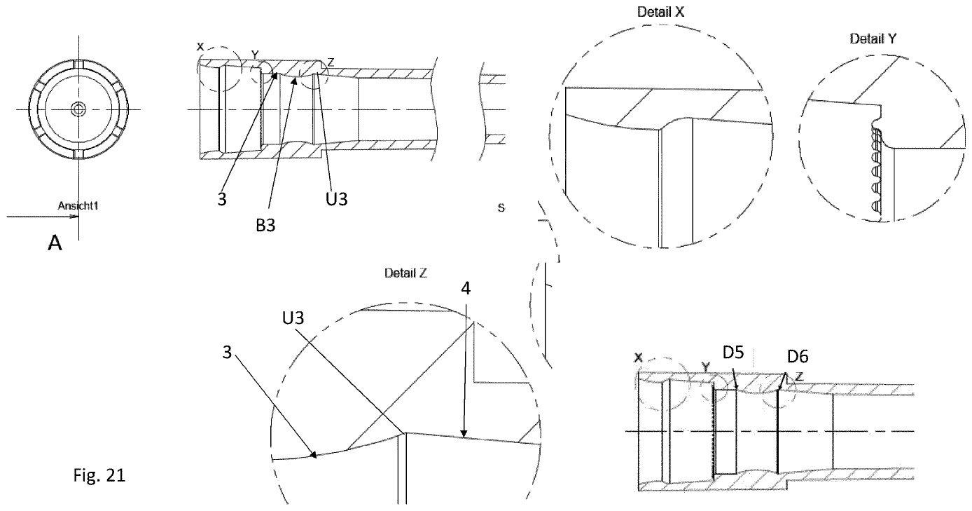

FIGS. 21-23 show further embodiments of the present disclosure, some of which are combinations of features of the preceding embodiments and some of which introduce new features. Any combinations, in particular of the details discussed, are intended to be within the scope of the disclosure.

Detail Y of FIG. 21 corresponds approximately to detail Y of FIG. 19. Sections 3 are formed with a bulbous, inwardly bulged bead B3, which at its lower end merges continuously via the transition area U3 into section 4. The section 4 may be (tapering) conical or cylindrical. The following may apply: D5 is less than or equal to D6.

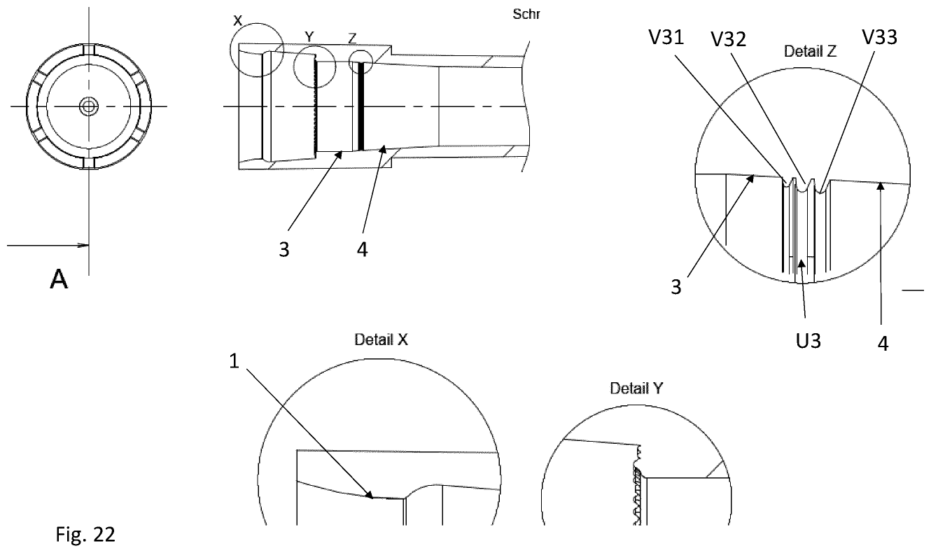

Detail Z of FIG. 22 is roughly comparable to a corresponding detail in the embodiment shown in FIG. 20, apart from the fact that in the embodiment shown in FIG. 22 the protrusions V31, V32, V33 have different radial heights. Further properties of the detail Y are described in connection with FIG. 20. In particular, it should be noted that the number of protrusions may be reduced to one protrusion or further protrusions may be added.

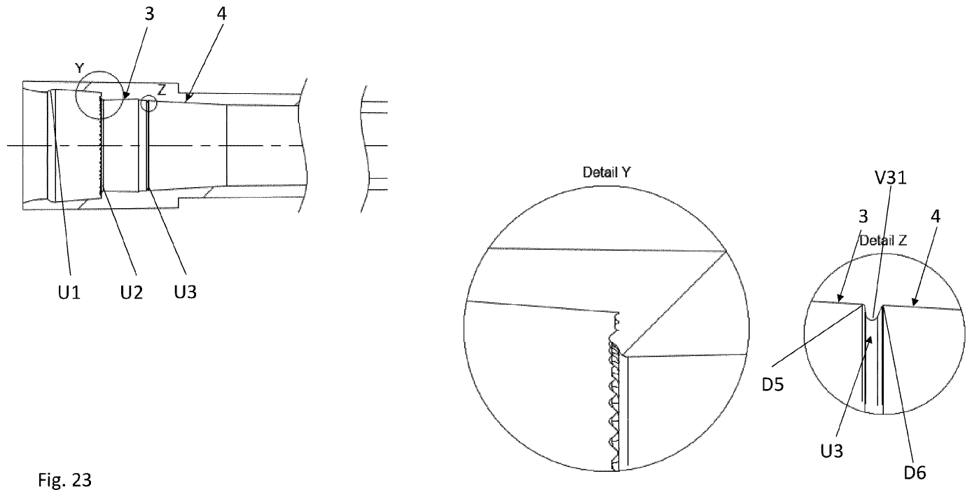

The embodiment in FIG. 23 corresponds to that in FIG. 22, except in the area of detail Z. In FIG. 23, only one radial protrusion V31 is provided, which is located between a cylindrical section 3 and a conical section 4, whereby the diameters of the regions directly at the top end of protrusion V31 of and at the bottom end of protrusion V31 are approximately equal, or even the diameter D6 in section 4 at the bottom end of protrusion V31 is larger than the diameter D5 at the top end of protrusion V31 in section 3.

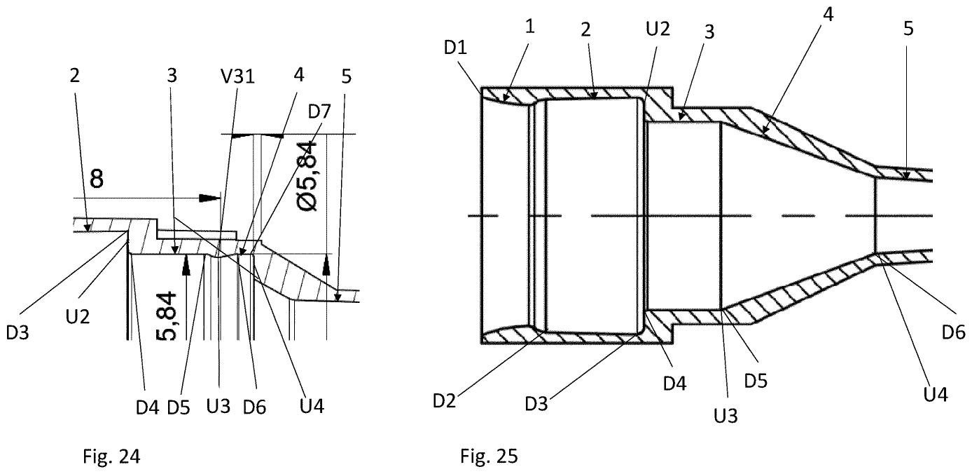

FIG. 24 shows a twenty-first particular embodiment of the present disclosure. Here, a conical section 2 (D2<D3) widening downwards (towards the second opening O2), a step-shaped transition U2 with a flat step surface, and a cylindrical or downwardly widening conical section 3 are provided (D3>D4, D4=D5 or D4<D5). Section 4 is also a cylindrical or downwardly widening conical section (D6=D7 or D6<D7).

The transition area U3 has a low, inwardly extending protrusion that is continuous in the circumferential direction. The diameter DV is smaller than D5 and D6. The following may apply: D5<D6.

In this embodiment example, the transition area U4 between the fourth section 4 and the fifth section 5 has a particular design. Transition area U4 has an inwardly extending radial step and a conical section adjoining the inner edge of the step, which merges into the fifth section 5. This embodiment may be useful for smaller filling volumes of the pipette tip.

FIG. 25 shows a twenty-second particular embodiment of the present disclosure. It has a first section 1 and a second section 2 (D2<D3) that widens conically (in the direction of the second opening O2). The transition area U2 corresponds to that of FIG. 24. The transition area U3 is adjoined by the third section 3, which is cylindrical in this embodiment (D4=D5). The transition U3 between the third section 3 and the fourth section 4 is continuous. The transition area U3 is an edge. The fourth section 4, which is designed as a tapered cone, directly adjoins the third section 3. At the lower end of the third section, i.e. at the transition U4 between the fourth section 4 and the fifth section 5, the likewise conically tapering section 5 is directly and continuously connected. The cone of section 5 is flatter than that of section 5.

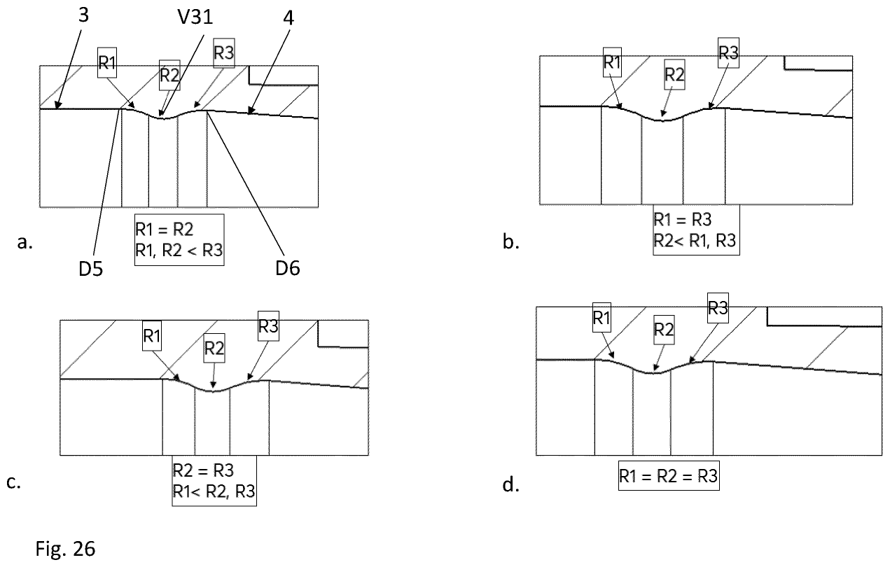

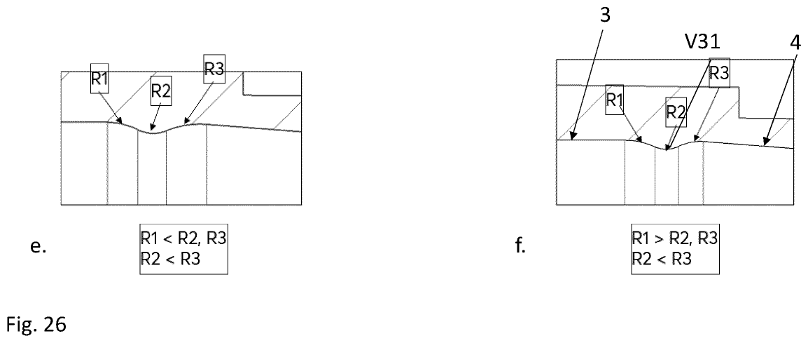

FIG. 26 shows different variants of the radii R1, R2 and R3 of a protrusion V31, as shown for example in FIGS. 22 and 23. In FIG. 26a.-f., the third section 3 and the fourth section 4 are each cylindrical, whereby the following applies for the diameters D5 and D6 at the upper end (in section 3) and at the lower end (in section 4) of the protrusion V31: D5=D6 or D5<D6.

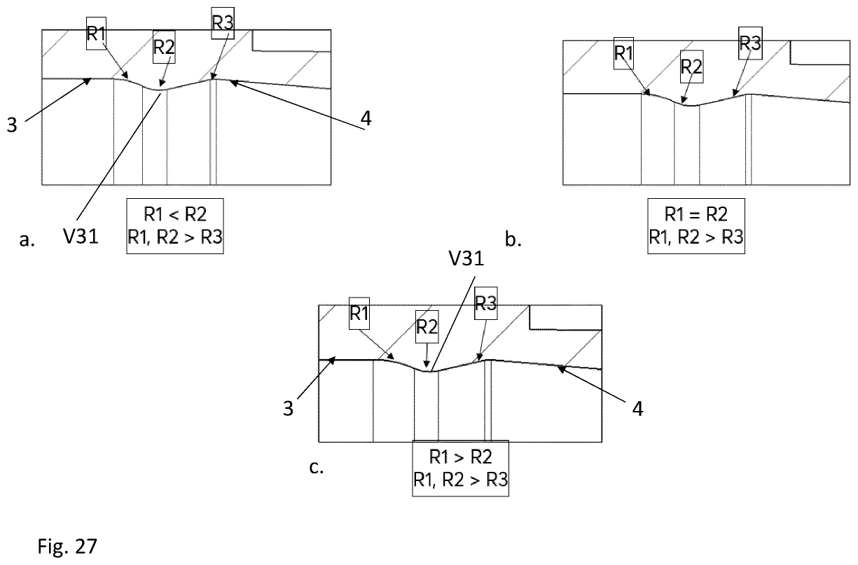

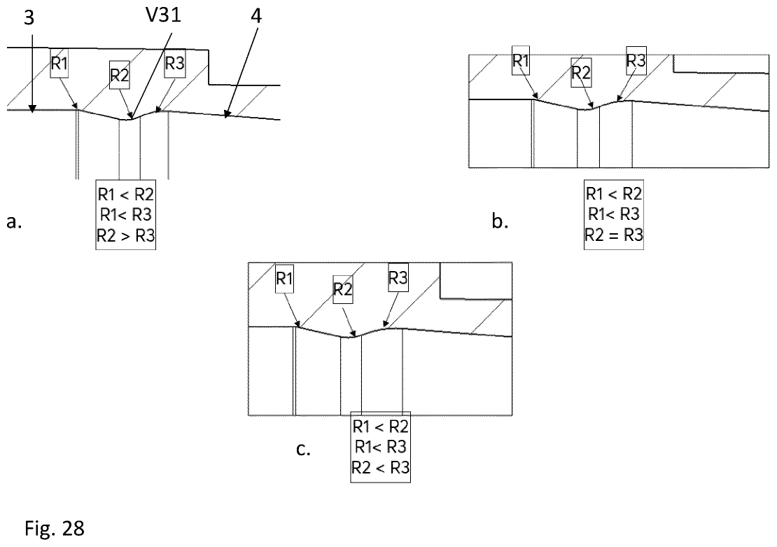

FIG. 27 and FIG. 28 show variants as in FIG. 26, except that in FIG. 27 the fourth section 4 at the lower end of protrusion V31 is conically tapered. However, it could also be designed to widen conically. In FIG. 28, the third section 3 at the top end of the protrusion V31 is tapered. However, it could also be designed to widen conically. Combinations of conical and cylindrical sections 3 and 4 and the conditions for the radii R1, R2, R3 for the protrusion V31 may be combined as desired.

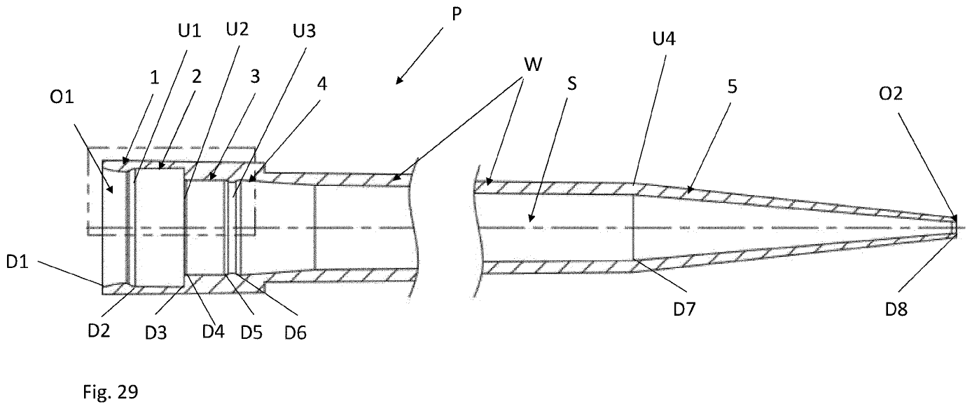

FIG. 29 shows a further embodiment of the present disclosure, which largely corresponds to the first embodiment and is not described in detail in this respect.

Unlike in the first embodiment, this pipette tip P has a third transition area U3, which may correspond in cross-section to the embodiments shown in FIGS. 26 to 28. In particular, the diameter D6 directly below the third transition area U3 is larger than the diameter D5 directly above the third transition area U3.

The second section 2 widens conically from top to bottom, i.e. D2 is smaller than D3. The third section 3 is essentially cylindrical with a diameter of D5.

1. A pipette tip, comprising:
a wall (W) defining an interior space (S);
a first, upper opening (O1) and a second, lower opening (O2), arranged at an upper end and a lower end of the interior space, respectively;
a first section (1) adjoining the upper opening (O1);
a second section (2) adjoining the first section;
a third section (3) adjoining the second section (2);
a fourth section (4) adjoining the third section; and
a fifth section (5) adjoining the fourth section (4) and ending in the lower opening;
a first transition area (U1) disposed between the first section (1) and the second section (2);
a second transition area (U2) disposed between the second section (2) and the third section (3); and
a third transition area (U3) disposed between the third section (3) and the fourth section (4);
wherein a diameter (D1) of the upper opening (O1) is larger than a diameter (D8) of the lower opening (02);
wherein the interior space (S) has at least cylindrical sections and/or sections tapering from top to bottom and/or transition areas; and
wherein the interior space (S) has at least one section and/or transition area which widens from top to bottom so that an undercut is formed.

2. The pipette tip according to claim 1, wherein the first section (1) has an upper diameter corresponding to the diameter (D1) of the upper opening (O1), a bulbously inwardly extending lower region with a diameter smaller than the diameter (D1) of the upper opening (O1), wherein the lower region of the first section (1) merges into the first transition area (U1), which has a diameter (D2) larger than the diameter of the lower region of the first section (1), so that the first transition area (U1) forms a first undercut.

3. The pipette tip according to claim 1, wherein the second section (2) adjoining the first transition area (U1) has a cylindrical and/or a conical inner contour tapering from top to bottom.

4. The pipette tip according to claim 1, wherein the second transition area (U2) adjoining the second section (2) has a conically tapering and/or radially inwardly extending step.

5. The pipette tip according to claim 1, wherein a diameter (D3) of the second section (2) immediately above the second transition area is greater than a diameter (D4) of the third section immediately below the second transition area (U2).

6. The pipette tip according to claim 1, wherein the second transition area (U2) has one or more protrusions or teeth extending axially upwards or with an axial extension component, which protrusions or teeth extend in a circumferential direction or are arranged at a distance from one another in the circumferential direction.

7. The pipette tip according to claim 1, wherein the third section (3) has a cylindrical and/or conically widening inner contour from top to bottom.

8. The pipette tip according to claim 1, wherein the fourth section (4) has a cylindrical and/or conically widening inner contour from top to bottom.

9. The pipette tip according to claim 1, wherein the third transition area (U3) between the third section (3) and the fourth section has at least one inwardly extending protrusion, wherein the smallest diameter of the third transition area (U3) is smaller than a diameter (D5) of the third section (3) immediately above the third transition area (U3) and smaller than a diameter (D6) of the fourth section (4) immediately below the third transition area (U3).

10. The pipette tip according to claim 1, wherein a diameter (D5) of the third section (3) immediately above the third transition area (U3) is smaller than a diameter (D6) of the fourth section (4) immediately below the third transition area (U3).

11. The pipette tip according to claim 1, wherein a diameter (D5) of the third section (3) immediately above the third transition area (U3) is greater than a diameter (D6) of the fourth section (4) immediately below the third transition area (U3).

12. The pipette tip according to claim 1, wherein the third section (3) has an inner contour which has at least one region widening from top to bottom to form a third undercut.

13. The pipette tip according to claim 1, wherein the second section (2) has an inner contour which has at least one region widening from top to bottom.

14. The pipette tip according to claim 1, wherein the third transition area comprises one or more protrusions (V31, V32, V33), wherein the protrusion has a first flank with a first radius (R1), a tip projecting radially towards a central axis of the interior space(S) with a second radius (R2) and a second flank with a third radius (R3), wherein the radii R1, R2, R3 fulfill the following conditions: R1=R2=R3, or R1=R2<R3, or R1=R3>R2, or R2=R3>R1, or R1<R2<R3, or R1>R2<R3.

15. The pipette tip according to claim 1, wherein the pipette tip is manufactured from plastic in one piece.

16. The pipette tip according to claim 1, wherein in the third section (3) the interior space(S) is cylindrical and/or conically tapering, and in the fourth section (4) is conically tapering, wherein a cross-sectional reduction of the fourth section (4) is greater than that of the third section (3), and wherein the third transition area (U3) is formed as an angle.

17. The pipette tip according to claim 16, wherein the third transition area (U3) is formed continuously in the form of an edge or a curvature.

18. An injection molding process for producing a pipette tip according to claim 1, the process comprising:
providing an injection molding cavity formed by an inner core and an outer sleeve and corresponding to a wall contour of the pipette tip;
introducing liquid plastic into the cavity;
solidifying the plastic;
removing the outer sleeve from an outer contour of the pipette tip while the pipette tip remains on the core; and
removing the pipette tip in axial direction from the core.

19. The injection molding process according to claim 18, wherein removing the outer sleeve comprises moving the sleeve or parts of the sleeve in a radial direction or in a direction having a radial directional component.
